(19) United States
(12) Patent Application Publication
(10) Pub. No.: US 2005/0224082 A1
(43) Pub. Date: Oct. 13, 2005

(54) Method for forming occlusive barrier over ear canal and kit for providing same

(76) Inventor: Arthur Alan Johnson, Erlanger, KY (US)

Correspondence Address: HASSE & NESBITT LLC, 7550 CENTRAL PARK BLVD., MASON, OH, 45040, US

(21) Appl. No.: 10/818,537

(22) Filed: Apr. 5, 2004

(51) Int. Cl. H04R 25/00

(52) U.S. Cl. 128/864

(57) ABSTRACT

A method for forming an occlusive, typically temporary barrier over the entrance of the ear canal of a user. The method comprises the steps of: (a) without entering the ear canal, covering the entrance of the ear canal of the user with a substrate capable of supporting the formation of an occlusive barrier that substantially covers the entrance to the ear canal while preventing the occlusive barrier from entering the ear canal; (b) applying to the substrate a composition capable of forming in situ a occlusive barrier thereon; and (c) allowing the applied composition to form the occlusive barrier on the substrate in a manner such that the occlusive barrier substantially prevents the entry of solid or liquid foreign matter into the ear canal. A kit can be provided that comprises (1) at least one component selected from: (a) a source of the substrate; and (b) a source of the composition for in situ formation of the occlusive barrier on the substrate; and (2) instructions associated with the at least one component which describe the method for forming the occlusive barrier on the substrate.

### TECHNICAL FIELD

This invention relates to a method for forming an occlusive, typically temporary barrier (e.g., earplug) over the ear canal and especially the entrance to the ear canal. This invention particularly relates to a method for forming such a barrier that does not require invasive insertion into the ear canal. This invention further relates to a kit for providing such an occlusive barrier.

### BACKGROUND OF THE INVENTION

It can be desirable in certain instances to prevent, at least temporarily, the entry of water and other undesired foreign matter into the ear canal. For example, as the result of surgery, infection or other trauma to the ear canal and surrounding tissues, the delicate tissues of the ear canal can become extremely sensitive and tender, and thus prone to pain, further injury or infection. In the case of water entering the ear canal, a pressure differential can result between the inner and outer ear, leading to pain and hearing problems during the water activity, as well as later. The exposure of the delicate and especially traumatized tissues of the ear canal to untreated water containing potentially harmful and infectious agents could also cause additional infection and traumatization of these tissues.

To avoid the attendant problems caused by water or other undesired foreign matter entering the ear canal, earplugs are often worn during, for example, bathing or showering, to prevent foreign matter, especially water, from entering the ear canal. Earplugs can be formed in situ from a deformable material such as wax that is injected or molded in place within the ear canal by appropriate pressure. See U.S. Pat. No. 5,718,244 (Thornton), issued Feb. 17, 1998, which discloses injecting a deformable material 18 into the ear canal 16 that is then be allowed to cool, coalesce or otherwise solidify into device 10 that conforms to the shape of the user's ear and U.S. Pat. No. 5,368,638 (Tokarz), issued Nov. 29, 1994, which discloses an ear plug composition formed of wax, a starch based acid ester, lanolin, grapefruit extract, etc. that includes cotton fibers to strengthen the composition so as to maintain the ear plug in one homogeneous mass. The earplug can also be in the form of preformed flexible cylindrical plugs that are inserted into the ear canal. See U.S. Pat. No. 5,573,015 (Williams), issued Nov. 12, 1996, which discloses one such extruded earplug. See also U.S. Pat. No. 5,488,961, which discloses an earplug with a lumen extending along the ear canal and a hydrophobic membrane extending across the lumen that admits air into or out of the ear canal. Custom-fitting earplugs can also be formed by disposing a foaming material within the ear canal and allowing the foaming material to expand, cure and set within the ear canal. See U.S. Pat. No. 5,131,411 (Casali et al), issued Jul. 21, 1992; U.S. Pat. No. 5,333,622 (Casali et al), issued Aug. 2, 1994, which disclose a custom-fitting earplug (18) that is fabricated in situ by depositing a foaming material (14 or 24) within the person's ear (10 or 42) and allowing the foaming material to expand therein to set up as a foam (16 or 44).

All of these prior earplugs and methods for forming same require the plug to be formed, positioned or inserted within at least a portion of the ear canal. If the delicate tissues of the ear canal are already traumatized as the result of surgery, infection or other injury, the invasive presence or insertion of the earplug can be extremely painful. Indeed, the application of pressure to conform the earplug to the shape of the ear canal, such as in the case of wax, or the pressure caused by the earplug expanding, such as in the case of in situ foam generation, against the wall of the ear canal can increase the degree of pain experienced. The extent the pain caused by the presence and/or formation of the earplug within the ear canal can be so great that the user is unable to tolerate it such that the user will not wear the earplug. In addition, the earplug itself can be contaminated with undesirable foreign matter or can introduce into the ear canal during formation thereof agents irritating to the tissues of the ear canal. As a result, some physicians do not suggest or recommend the use of earplugs in such instances because of their invasive nature. In addition, some earplugs formed in situ, such as those formed from wax, tend not to stay in place.

Accordingly, it would be desirable to provide an earplug or other occlusive barrier for preventing the entry of water and other foreign matter into the ear canal that does not cause significant pain to the delicate tissues thereof. It would be particularly desirable to be able to provide an earplug or other occlusive barrier that does not require intrusive entry into or presence in the ear canal, especially when the tissues of the ear canal are traumatized or otherwise extremely sensitive to any materials that might touch or come into contact with them.

### BRIEF DESCRIPTION OF THE INVENTION

This invention is broadly directed at a method for forming an occlusive and typically temporary barrier (e.g., earplug) over the entrance of the ear canal of a user in need thereof. This method comprises the steps of:
a. without entering the ear canal, covering the entrance of the ear canal of the user with a substrate capable of supporting the formation of an occlusive barrier while preventing the occlusive barrier from entering the ear canal;
b. applying to the substrate a composition capable of forming in situ an occlusive barrier thereon; and
c. allowing the applied composition to form the occlusive barrier on the substrate in a manner such that the occlusive barrier substantially covers the entrance of the ear canal and substantially prevents the entry of solid or liquid foreign matter therein.

This invention further relates to a kit for forming, typically temporarily, an earplug that comprises this substrate and occlusive barrier. This kit comprises:
1. at least one component selected from:
   a. a source of the substrate for forming the occlusive barrier thereon; and
   b. a source of the composition for in situ formation of the occlusive barrier on the substrate; and
2. instructions associated with the at least one component which describe the method for forming the occlusive barrier on the substrate.

The method of this invention provides a number of benefits and advantages for persons requiring an occlusive, typically temporary barrier or earplug over the ear canal. Because the substrate is positioned and the occlusive barrier is formed outside the ear canal, the potential for causing pain to the wearer of the earplug is avoided or minimized. The occlusive barrier can be formed from readily available compositions on substrates that are also readily available. The ear plug that is formed from the combination of the substrate and occlusive barrier is expected to temporarily protect the ear from water and other foreign matter and can be formed in a manner such that it can be easily peeled away and discarded when it is no longer needed. The ear plug of this invention and method for forming same not only minimizes pain and/or discomfort of the user, but also minimizes the likelihood of infection from contamination that can result from earplugs that need to be inserted into the ear canal to provide an occlusive barrier.

### BRIEF DESCRIPTION OF THE DRAWINGS

FIG. 1 is a side sectional view showing an embodiment of the earplug formed by the method of this invention.

FIG. 2 is perspective view showing the earplug formed by the method of this invention substantially covering the entrance to the ear canal.

### DETAILED DESCRIPTION OF THE INVENTION

As used herein, the term “comprising” means various components, steps and the like can be conjointly employed in this invention. Accordingly, the term “comprising” encompasses the more restrictive terms “consisting essentially of” and “consisting of.”

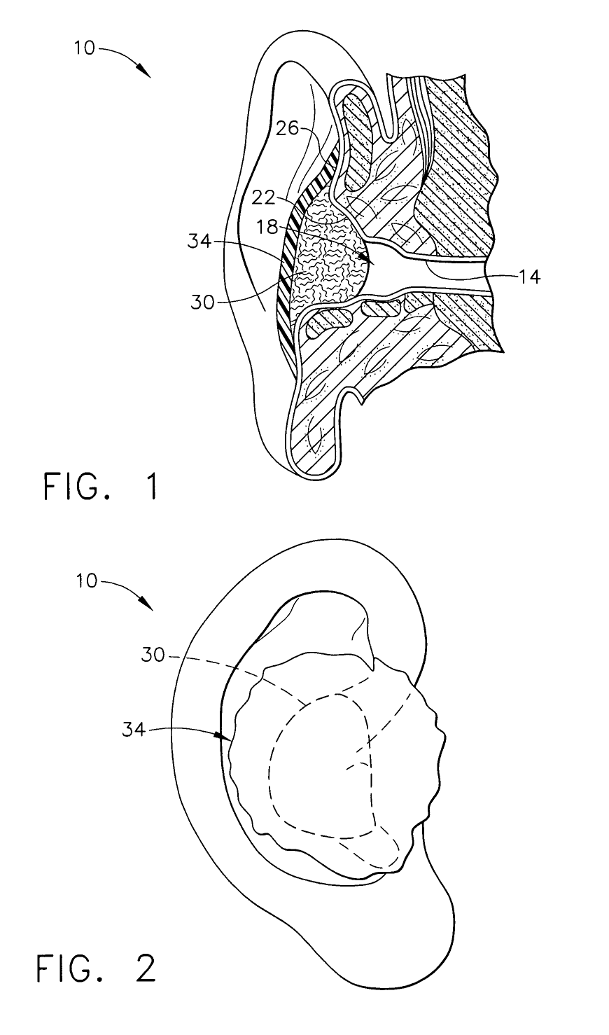

The various embodiments of this invention are further illustrated by reference to the drawings as described hereafter. Referring to the drawings, FIG. 1 shows the ear of the user indicated generally as 10. The ear canal is indicated generally as 14 and has an entrance or opening indicated as 18 that connects ear canal 14 with the concha 22 of the external portion or surface of ear 10.

In practicing the method of this invention, and as shown in FIGS. 1 and 2, the entrance 18 of ear canal 14 is initially covered either partially or typically substantially completely with a substrate indicated as 26 that is typically conformed to the shape of concha 22 so that it is held in place therein. As shown in FIG. 1, substrate 26 covers entrance 18 of ear canal 14 without entering or being inserted into ear canal 14. As a result, substrate 26 does not cause or at least minimizes irritation, pressure or other pain generating forces on the delicate tissues of ear canal 14. This is particularly important if the tissues of ear canal 14 have been sensitized, inflamed or traumatized due to surgery, inflammation, infection, injury or other traumatization of ear canal 14.

Substrate 26 can be of any suitable shape or configuration for covering the entrance 18 of ear canal 14. Substrate 26 can be in a preformed shape or configuration before being positioned to cover the entrance 18 of ear canal 14, or can be manipulated into a suitable or desired shape, such as to conform to the configuration or shape of concha 22. Suitable shapes that substrate 26 can be preformed or manipulated into include circular, oval or elliptical, square, rectangular. More typically, substrate 26 has a circular or oval shape similar or conforming to the shape of concha 22 of the user, as well as the shape of entrance 18 of ear canal 14. Suitable substrates 26 can be formed from any of a variety of materials including cotton, silk, wool, or synthetic fibers such as nylon, polyester, rayon, Dacron and the like, foamed or unfoamed polymers and plastics, rubber or latexes, and the like, and can be in the form of woven or nonwoven materials such as woven or nonwoven fabrics, films, webs, strips, or sheets. Substrate 26 can be partially or completely impervious to fluids (e.g., water or air) as long as substrate 26 is capable of preventing the occlusive barrier from entering ear canal 14. Typically, substrate 26 is at least partially pervious to liquids such that it can partially absorb or retain the composition applied thereto for forming the occlusive barrier. Suitable forms of substrates 26 for use herein include, but are not limited to cotton balls, cotton swabs, gauze, surgical dressings, bandages (e.g., Band-Aid type), tape (e.g., medical tape), patches formed from various woven and nonwoven materials, and the like. If desired, a mildly or slightly adhesive material can be pre-applied to or associated with substrate 26 to at least temporarily hold it in place within concha 22 until the occlusive barrier is applied and/or formed on substrate 26.

Once substrate 26 is in place over the entrance 18 to ear canal 14, a composition capable of forming an occlusive barrier in situ can then be typically applied to substrate 26. The occlusive barrier that forms from the application of this composition on substrate 26 is indicated generally as 30 in FIGS. 1 and 2. Occlusive barrier 30 desirably forms a complete or substantially complete seal around and over entrance 18 of ear canal 14 so that water and other foreign matter cannot enter ear canal 14, or is at least substantially prevented from entering ear canal 14. Most importantly, occlusive barrier 30 is formed on substrate 26 in a manner such that barrier 30 does not enter or penetrate into ear canal 14. This occlusive barrier 30 can be in the form of any rigid, semi-rigid or flexible material that can be formed in situ on substrate 26, and can desirably adhere to or be absorbed by substrate 26 so that it does not readily fall off or out of ear 14 (e.g., concha 22) during use. Occlusive barrier 30 can be of any desired thickness, but is typically relatively thin, e.g., about 1 mm or less in thickness.

The composition for forming occlusive barrier 30 can be applied to substrate 26 in a variety of ways, including spraying, extruding, injecting, painting, dabbing, coating, pouring, spreading or any combination thereof. The composition for forming occlusive barrier 30 can have any texture suitable for such methods of application including viscous, semi-viscous or relatively fluid textures, and is desirably non-toxic and substantially non-irritating to the skin. The composition for forming occlusive barrier 30 can be provided in any suitable form, including but not limited to aerosol spray products that are provided with a suitable propellant for discharging or expelling the composition (with or without foaming), extruded products (with or without foaming) onto substrate 26, pastes or putties, or relatively viscous fluids. To form the occlusive barrier in situ, the composition that is applied to substrate 26 typically needs to set up or cure at or about ambient temperature (typically room temperature), and usually at a temperature in the range of from about 10° to about 40° C., more typically in the range of from about 20° to about 25° C. While the composition for forming occlusive barrier 30 should desirably set up or cure relatively quickly after application to substrate 26 (e.g., within a few minutes), compositions suitable for use herein can set up or cure over longer periods of time as long they remain adhered retained or absorbed by substrate 26.

The composition for forming occlusive barrier 30 can also comprise a material, such as wax, that is capable of forming the occlusive barrier, and is at least partially soluble in a suitable organic solvent that is non-toxic and is substantially non-irritating to the skin. When such a composition is applied to substrate 26, the solvent can be allowed to evaporate or otherwise appropriately removed, so that the partially or completely dissolved material sets up to form occlusive barrier 30 on substrate 26.

The occlusive barrier 30 is more typically formed on substrate 26 from a composition that cures and/or sets up as a rubbery material, or as a foamed or unfoamed rigid, semi-rigid or flexible polymer or plastic. Suitable compositions for forming such occlusive barriers include but are not limited to: (1) prepolymers that more fully polymerize, cure and set up to form the occlusive barrier at ambient, or more typically room temperature, upon exposure to air, or when combined with an appropriate accelerator or setting agent that is either a component of the prepolymer product or is part of or previously applied to substrate 26; and (2) polymers that form, set up and cure at ambient, or more typically room temperature, to form the occlusive barrier when two or more separated components are combined and reacted together. Suitable polymer compositions for forming such occlusive barriers in situ at ambient, and typically room temperature, include, but are not limited to: acrylic, styrene-butadiene and other rubbery latexes; silicone rubber compositions that are curable at room temperature to form rubbery or flexible webs such as one package silicone rubber compositions containing a silanol-terminated diorganopolysiloxane base polymer and an organotriacyloxysilane disclosed in U.S. Pat. No. 3,701,753 (Shaw), issued Oct. 31, 1972 (herein incorporated by reference), two part silicone rubber compositions where one part comprises linear organopolysiloxanes having terminal silicon-bonded hydroxy groups and the other part comprises an alkyl silicate and a metallic salt of an organic monocarboxylic or dicarboxylic acid disclosed in U.S. Pat. No. 3,925,277 (Lampe), issued Dec. 9, 1975 (herein incorporated by reference) and elastomeric silicone materials formed from combinations of room temperature curable silicon rubbers, silicone foam rubbers and polysiloxanes disclosed in U.S. Pat. No. 3,344,220 (Cook), issued Sep. 26, 1967 (herein incorporated by reference); room temperature curable foamed or unfoamed rigid, semi-rigid or flexible polyesters, including aliphatic polyesters such as polycaprolactone polymers (e.g., TONE polycaprolactone polymers) disclosed in U.S. Pat. No. 5,713,244 (Thornton), issued Feb. 17, 1998 (herein incorporated by reference) and copolyester compositions comprising, in polymerized form, polymethylene glycol units, aliphatic dicarboxylic acid units of 5 to 10 carbon units and isophthalic acid units disclosed in U.S. Pat. No. 3,959,200 (Scott), issued May 25, 1976 (herein incorporated by reference); room temperature curable foamed or unfoamed rigid, semi-rigid or flexible polyurethanes; room temperature curable foamed or unfoamed rigid, semi-rigid or flexible polyethers; and the like.

The substrate 26 and occlusive barrier 30 together form or comprise the earplug of this invention that is indicated generally as 34 in FIGS. 1 and 2. As shown in FIGS. 1 and 2, earplug 34, when formed, provides a complete or substantially complete seal over entrance 18 of ear canal 14 so that water and other foreign matter cannot or is substantially prevented from entering ear canal 14. Earplug 34 can be formed so as to provide an occlusive barrier that can be worn for a relatively extended period of time. However, earplug 34 is typically formed to provide an occlusive barrier that is expected to temporarily protect ear canal 14 from the entry of such water or other foreign matter. For example, a temporary earplug 34 can be formed in a manner such that it can be easily peeled away and discarded when the user no longer needs it.

An embodiment of this invention also includes a kit for forming such an earplug 34. This kit is provided with one or more of the following components: (a) a source of substrate 26; and (b) a source of the composition for forming the occlusive barrier 30. Substrate 26 can be in the form of: (1) a plurality of single units that are separately packaged or unpackaged; (2) a single mass, film, strip, sheet or web of material from which a plurality of individual units of substrate 26 can be prepared for use in forming earplug 34; or (3) a single mass, film, strip, sheet or web of material that is scored, marked or otherwise divided to provide a plurality of individual units that are easily detached or separated from the mass, film, strip, sheet or web. The source of the composition can be in the form of: (a) a plurality of separate single use units that are each used to form a single occlusive barrier 30; (b) a plurality of single use units that are connected together but easily detached therefrom (e.g., a “blister” package) to each form a single occlusive barrier 30; or (c) a single unit, package or container having sufficient capacity to be capable of being used a plurality of times to form a plurality of occlusive barriers 30. Optionally, the kit can be provided with a device for applying the composition to substrate 26, or for preventing the composition from being applied outside the desired area of use (e.g., getting on the user's skin outside the area of ear 10 where needed, the user's clothes or in the user's hair). For example, the device can comprise a piece of cardboard, paper, plastic, or other material that is formed or shaped into a guide for applying the composition onto substrate 26, as well as to keep it away from other undesired areas of the user's body (e.g., hair) or clothes.

The kit can also be provided with a set of instructions for how to cover entrance 18 to ear canal 14 with substrate 26, and how to form occlusive barrier 30 on substrate 26 so as to provide a completed earplug 34. These instructions can be written or printed on the packaging that the kit is sold or distributed in or with, or on a sheet(s) of paper separately therefrom. Alternatively, the kit can include computer software (e.g., in the form of a floppy disk(s), CD ROM disk(s) or other non-volatile electronic storage media) packaged or otherwise associated with the kit that provides the instructions on how to form the occlusive barrier 30 on substrate 26, or the instructions can be provided and obtained electronically (e.g., via the Internet) from a remote site such as from a web site or computer server.

While specific embodiments of this invention have been described, it will be apparent to those skilled in the art that various modifications thereto can be made without departing from the spirit and scope of this invention as defined in the appended claims.

1. A method for providing an occlusive barrier over the entrance of an ear canal of a user, the method comprising the steps of:
a. without entering the ear canal, covering the entrance of the ear canal of the user with a substrate capable of supporting the formation of an occlusive barrier while preventing the occlusive barrier from entering the ear canal;
b. applying to the substrate a composition capable of forming in situ an occlusive barrier thereon; and
c. allowing the applied composition to form the occlusive barrier on the substrate in a manner such that the occlusive barrier substantially covers the entrance of the ear canal and substantially prevents the entry of solid or liquid foreign matter therein.

2. The method of claim 1 wherein the substrate has a shape that is circular, oval, square, rectangular or conformed to the shape of the user's concha.

3. The method of claim 2 wherein the substrate is conformed to the shape of the user's concha.

4. The method of claim 1 wherein the substrate is formed from materials selected from the group consisting of cotton, silk, wool, synthetic fibers, polymers, rubbers or latexes.

5. The method of claim 4 wherein the substrate is in the form of a cotton ball, cotton swab, gauze, surgical dressing, bandage, tape or patch.

6. The method of claim 1 wherein the substrate has a slightly adhesive material associated therewith for at least temporarily holding the substrate in place until the composition is applied thereto.

7. The method of claim 1 wherein the composition is applied to the substrate by spraying, extruding, injecting, painting, dabbing or coating, pouring, spreading or combination thereof.

8. The method of claim 6 wherein the composition is applied to the substrate by spraying.

9. The method of claim 1 wherein the occlusive barrier is formed on the substrate from a material selected from the group consisting of rubbery materials, foamed polymers and unfoamed polymers.

10. The method of claim 8 wherein the composition comprises: (1) a prepolymer that more fully polymerizes, cures and sets at ambient temperature; or (2) two or more components that, when combined, react together to form a polymer that cures and sets at ambient temperature.

11. The method of claim 1 wherein the occlusive barrier that is formed is temporary and can be peeled way when no longer needed by the user.

12. A kit for forming an earplug that provides an occlusive barrier over the entrance of the ear canal of a user, which comprises:
1. at least one component selected from:
a. a source of a substrate for supporting the formation of an occlusive barrier that is capable of covering the entrance to the ear canal and is capable of preventing the occlusive barrier from entering the ear canal;
b. a source of a composition capable of forming the occlusive barrier in situ on the substrate; and
2. instructions associated with the at least one component which describe a method, which comprises the steps of:
a. without entering the ear canal, covering the entrance of the ear canal of the user with the substrate;
b. applying the composition on the substrate; and
c. allowing the applied composition to form the occlusive barrier on the substrate so as to form the earplug in a manner such that the occlusive barrier substantially covers the entrance of the ear canal and substantially prevents the entry of solid or liquid foreign matter therein.

13. The kit of claim 12 which comprises both a source of the substrate and a source of the composition.

14. The kit of claim 12 wherein the source of the substrate is capable of providing a plurality of single use units of the substrate.

15. The kit of claim 14 wherein the source of the substrate comprises a web that is divided to provide a plurality of detachable single use units of the substrate.

16. The kit of claim 12 wherein the source of the composition is capable of forming a plurality of occlusive barriers.

17. The kit of claim 12 wherein the instructions are written on at least one sheet of paper.

18. The kit of claim 12 wherein the instructions are written on the packaging for the kit.

19. The kit of claim 12 wherein the instructions are provided on computer software.

20. The kit of claim 12 which further includes a device for guiding the application of the composition on the substrate.
